(19) United States
(12) Patent Application Publication
(10) Pub. No.: US 2016/0357579 A1
(43) Pub. Date: Dec. 8, 2016

(54) LOCALE-AWARE CUSTOMIZATION OF PUBLIC CONTENT

(71) Applicant: International Business Machines Corporation, Armonk, NY (US)

(72) Inventors: Su Liu, Austin, TX (US); Eric J. Rozner, Austin, TX (US); Chin Ngai Sze, Austin, TX (US); Yaoguang Wei, Austin, TX (US)

(73) Assignee: International Business Machines Corporation, Armonk, NY (US)

(21) Appl. No.: 14/833,376

(22) Filed: Aug. 24, 2015

Related U.S. Application Data
(63) Continuation of application No. 14/730,179, filed on Jun. 3, 2015.

(51) Int. Cl. G06F 9/44; H04L 29/08; H04W 4/02

(52) U.S. Cl. CPC G06F 9/4448; H04W 4/02; H04L 67/306

(57) ABSTRACT

For customizing content according to a dynamically changing audience, a mobile device associated with a member of the audience is detected to be present within a defined area. A locale preference corresponding to the member is collected from the mobile device. The locale preference is analyzed to determine whether the locale preference is also a locale preference of a threshold number of members of the audience. When the locale preference is also the locale preference of the threshold number of members of the audience, the locale preference is weighted according to a weighting rule to form a weighted common locale preference. When a weight of the weighted common locale preference exceeds a threshold weight, the weighted common locale preference is selected and used to configure the content, forming customized content. The customized content is delivered to a public presentation device present in the defined area.

### TECHNICAL FIELD

The present invention relates generally to a method for displaying digital content in public environments. More particularly, the present invention relates to a method for locale-aware customization of public content.

### BACKGROUND

A public environment or a public place is any physical place or space where members of the public congregate. Public environments, such as airports, waiting areas, and shopping malls often have electronic presentation devices on which digital content is presented to the nearby audience while the audience is present in the public environment.

Generally, such an electronic presentation device, hereinafter referred to as a “public board”, includes audible output capabilities, visible display capabilities, or both. The audience of a public board is the group of members of the public who are physically situated within a defined distance from the public board. As people move through the public environment, the composition of the audience of a public board changes from time to time.

A public board is used to present audible content, visible content, or both, (collectively and interchangeably referred to hereinafter as “content”). Presently, the content presented using a public board is pre-defined content, and is presented in a pre-defined manner of presentation, such as in a language, style, or configuration preset by the content provider.

### SUMMARY

The illustrative embodiments provide a method for locale-aware customization of public content. An embodiment includes a method for customizing content according to a dynamically changing audience. The embodiment detects that a mobile device is present within a defined area, the mobile device being associated with a first member of the audience. The embodiment collects, from the mobile device, a first locale preference corresponding to the first member. The embodiment analyzes the first locale preference to determine whether the first locale preference is also a locale preference of a threshold number of members of the audience. The embodiment weights, responsive to the first locale preference also being the locale preference of the threshold number of members of the audience, the first locale preference according to a weighting rule to form a weighted common locale preference. The embodiment selects, responsive to a weight of the weighted common locale preference exceeding a threshold weight, the weighted common locale preference for the content. The embodiment configures the content according to the weighted common locale preference, forming customized content. The embodiment delivers the customized content to a public presentation device present in the defined area.

Another embodiment includes a computer usable program product comprising a computer readable storage device including computer usable code for customizing content according to a dynamically changing audience.

Another embodiment includes a data processing system for customizing content according to a dynamically changing audience.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for locale-aware customization of public content in accordance with an illustrative embodiment;

FIG. 4 depicts a configuration to collect locale preferences from an audience in accordance with an illustrative embodiment;

FIG. 5 depicts a flowchart of an example process for locale-aware customization of public content in accordance with an illustrative embodiment.

### DETAILED DESCRIPTION

The illustrative embodiments recognize that the presently-used pre-defined manner of presenting content on a public board fails to take into account the dynamically changing audience of the public board and the correspondingly dynamic preferences of that audience. For example, at an airport, the audience comprises the passengers that are awaiting their flight at a gate, where the gate is within a defined distance of a public board. When the audience comprises passengers who are awaiting a flight to Japan, there is a greater than a threshold probability that the audience will include individuals who speak a dialect of the Japanese language, and are used to seeing certain Japanese locale-specific presentation of information. When the audience comprises passengers who are awaiting a flight to India, there is a greater than a threshold probability that the audience will include individuals who speak the Hindi language, and are used to seeing certain Indian locale-specific presentation of information.

A language preference is a natural language preferred by an individual or a group for audible communication, visual communication, or both. A locale preference includes one or more settings or configurations of the content that is presented according to the language preference. For example, one example manifestation of a locale preference may include four variables such as [language code, script code (optional, only used to distinguish multiple scripts in single language, such as Hans script and Hant script in the Chinese language), region or territory code, encoding]. More than these four variables are also known to specify a locale preference.

As an example, a language preference may be Hindi. A corresponding locale preference can be [hi, IN, UTF-8], where “hi” is a language code for Hindi, IN is a region code for India, and UTF-8 is an encoding specification for encoding content in Hindi for India region in Unicode standard. As another example, a language preference may be Japanese. A corresponding locale preference can be [ja, JP, UTF-8 or IBM-943 or IBM-eucJP], where “ja” is a language code for Japanese, JP is a region code for Japan, and each of UTF-8, IBM-943, and IBM-eucJP is a usable encoding specification for encoding content in Japanese for Japan region.

Locale affects the presentation of the content. For example, currency values are demarcated differently in different digit groups according to different locales, date is formatted differently in different locales, and phone numbers, time information, and many other pieces of information is presented differently according to different locales. For example, what may mean a month value in a date in a US locale may mean a day value in the date in a UK locale. Audio content is also encoded differently according to different locales. Essentially, locale information determines a manner of encoding the content, presenting the content, or both, depending on the nature of the content and the application that is presenting the content.

The illustrative embodiments recognize that presently, content is presented on public boards without regard to the locale preferences of the audience of the public board at the time of the presentation of the content. For example, regardless of the composition of the audience waiting at the gate in the above example, an airport in the United States presents content in English on the public board.

The illustrative embodiments recognize that it is important not only to deliver content in a suitable language and locale, but also to select content that matches an audience's interest. The illustrative embodiments recognize that for delivering a message or achieving an objective via content presentation to audiences of public boards, presenting content that is wanted, preferred, favored, liked, or of interest to members of an audience, in a language and locale preference of the members of the audience, is more effective as compared to delivering preselected content in preselected language or locale settings.

Thus, the illustrative embodiments recognize that under some circumstances, the audience, or a part of the audience can have a common interest as well. For example, cultural influences may cause member of an audience to be more interested in political content than entertainment related content. As another example, if the audience includes passengers awaiting a flight to Spain during the running of the bulls season, it is likely that the audience will be interested in the content related sporting events. In some cases, the members of the audience may coincidently have similar interests.

Just as some members of an audience can have a common locale preference, some members of the audience can also have a common interest. The illustrative embodiments further recognize that not only is the content not presented according to a common locale preference of the audience, the content is also not dynamically selected according to a common interest of the audience.

The illustrative embodiments recognize that customizing the content presented on public boards according to the dynamic locale preferences of an audience, and optionally also according to dynamic interest preferences of the audience will be useful improves the effectiveness of the content. For example, if the content is an advertisement, customizing the advertisement in this manner makes the advertisement relevant to the audience that is present in a defined vicinity of the public board at a given time. A vicinity of a public board is an area bound by one or more distances from the public board. Thus, the illustrative embodiments recognize that customizing the content presented on public boards according to the dynamic locale preferences of an audience, and optionally also according to dynamic interest preferences of the audience will be useful.

The illustrative embodiments used to describe the invention generally address and solve the above-described problems and other problems related to the presentation of content to a dynamic audience using a public board. The illustrative embodiments provide a method for locale-aware customization of public content.

One or more embodiments described herein can be implemented as an application executing using a processor and a memory in a public board, or as an application executing in a processing unit coupled with a public board via a data network.

An embodiment detects the presence of a member of an audience in a vicinity of a public board. Specifically, the embodiment detects that a mobile device associated with the member of the audience is physically situated within a defined distance from the public board.

One embodiment detects the presence of the mobile device by sensing, detecting, or otherwise receiving wireless communications occurring between the mobile device and another system. For example, a mobile device requesting Wi-Fi connection from a router or access point reveals the presence of the mobile device within a defined distance from the router or the access point. When the distance between the router or the access point and the public board is known by a previous measurement, the embodiment can determine whether the device is present within the vicinity of the public board.

Another embodiment detects the presence of the mobile device by sensing, detecting, or otherwise receiving wireless communications occurring between the mobile device and a system of a wireless service provider. For example, a mobile device connecting to a base station reveals the presence of the mobile device by triangulation with other base stations. Using the triangulation data, the embodiment can determine whether the device is present within the vicinity of the public board.

A measurement of a signal strength of a mobile device's signal, a computation of a delay in a communication with the mobile device, an attempt to connect to the mobile device with a specified signal strength are some more example manners of detecting the presence of a mobile device within a vicinity of a public board. These examples of detecting a mobile device's presence within a vicinity of a public board are not intended to be limiting. From this disclosure, those of ordinary skill in the art will be able to conceive many other ways for similarly purposed detection and the same are contemplated within the scope of the illustrative embodiments.

An embodiment collects a locale preference corresponding to the detected mobile device. For example, one embodiment receives the locale preference information from the mobile device, such as by sensing, detecting, or otherwise receiving the locale information as a part of a communication between the mobile device and another system. As a non-limiting example of such a manner of receiving the locale information, one embodiment receives the locale preference as a part of a Wi-Fi network connection setup between the mobile device and a wireless router or access point.

Another example embodiment detects a channel or frequency used by the mobile device to communicate with a service provider. Different service providers in different regions use different channels, frequencies, or both. Thus, the channel or frequency used by a device, and detected by the embodiment can reveal the device's locale to the embodiment.

Another example embodiment requests the locale preference from a mobile device. In some cases, the mobile device responds with the locale preference.

Another example embodiment detects data traffic of a mobile device, such as data to and from a browser or social media application in the mobile device, to determine the locale preference. Under certain circumstances, the data traffic of a device detected by the embodiment can reveal the device's locale to the embodiment.

Another example embodiment detects a communication from a mobile device where the communication includes an identifier associated with the mobile device. The embodiment communicates with the service provider to request the locale preference of the mobile device associated with the identifier. Under certain circumstances, the service provider provides the device's locale to the embodiment.

These examples of determining a locale preference of a mobile device are not intended to be limiting. From this disclosure, those of ordinary skill in the art will be able to conceive many other ways of determining the locale preference of a mobile device and the same are contemplated within the scope of the illustrative embodiments.

An embodiment analyzes the locale information collected from one or more mobile devices corresponding to one or more members of a dynamic audience at a given time. The analysis determines whether any common locale preferences exist amongst at least some of the members of the audience.

Not only the locale information, but additional information, such as a user profile, topics of interests, bookmarks, favorite websites list, blocked content list, dislikes, or some combination thereof may also be received at an embodiment. For example, such information may be present in a communication between the mobile device and another system, website, or social media server.

One embodiment further analyzes the information collected from one or more mobile devices corresponding to one or more members of a dynamic audience at a given time. The analysis determines whether any common interests exist amongst at least some of the members of the audience.

It is possible that more than one common locale preference, more than one common interest, or a combination thereof, may be identified in this manner in the given audience at the given time. An embodiment identifies all common locale preferences that are shared by greater than a threshold number of members of the audience. An embodiment similarly identifies all common interests that are shared by greater than another threshold number of members of the audience.

An embodiment applies a weighting rule to the various locale preferences, including the one or more common locale preferences. A weighting rule changes an influence of a locale preference in a mix of locale preferences.

For example, assume that an embodiment is executing in Quebec province of Canada, and a given example audience of ten members includes three French speaking members, four English speaking members, and the remaining members preferring some other languages. A weighting rule may provide that as long as more than one French-speaking member is present in the audience, the content should be presented in both French and English, with the French presentation being first in an order of presentation. In other words, even though the French-speaking members are not a clear majority, a weighting rule may accord higher weight to French locale preference than to English locale preference, causing the content to be presented in French only or French first.

Another example weighting rule may provide that any emergency related content must be presented in a designated locale setting only, or in a designated locale setting first. Any type of content, without the content being emergency-related, can be associated with a weighting rule in this manner.

Another example weighting rule may provide that if a number of members sharing a common locale preference does not exceed the threshold, the content should be presented in a designated locale setting only, or in a designated locale setting first. Another example weighting rule may provide that if more than one common locale preference is identified, the content should be presented in a preferred one of the several common locale settings, or in a designated order of the common locale settings.

Similarly, weighting rules can be applied to common interests. For example, a weighting rule may provide that if a number of members sharing a common interest does not exceed the threshold, a default content should be presented in a designated locale setting only, or in a common locale setting, or in one of the several common locale settings first. Another example weighting rule may provide that if more than one common interest are found, the content pertaining to one or more of the common interests should be presented in a designated locale setting only, or in a designated locale setting first.

Another example weighting rule may provide that a certain common interest should receive no weight even if the number of members sharing the common interest exceeds a specified threshold. Another example weighting rule may provide that a particular interest should be weighted higher than another interest.

These examples of weighting rules are not intended to be limiting. From this disclosure, those of ordinary skill in the art will be able to conceive many other weighting rules and the same are contemplated within the scope of the illustrative embodiments.

Based on the weighted common locale preference, an embodiment selects the content to present on the public board. The embodiment configures the selected content according to the weighted common locale preference. When more than one weighted common locale preferences are to be used, the embodiment arranges the presentation of the selected content configured according to the various weighted common locale preferences in an order according to a logic, rule, or specification.

When a weighted common interest is available, an embodiment uses the weighted common interest in combination with the weighted common locale preference to select the content. The selected content corresponds to the weighted common interest. The embodiment configures the selected content of interest according to the weighted common locale preference.

When more than one weighted common locale preferences are to be used, the embodiment arranges the presentation of the selected content of interest, configured according to the various weighted common locale preferences, in an order according to a logic, rule, or specification. When more than one weighted common interests are to be used, the embodiment arranges the presentation of the selected contents corresponding to the various interests, configured according to the one or more weighted common locale preferences, in an order according to a logic, rule, or specification.

An embodiment delivers the configured content or configured content of interest to the public board. An embodiment continues to evaluate the dynamic audience from time to time to re-determine the identified common locales preferences, common interests, or some combination thereof, and to dynamically adjust the content being presented on the local board.

A method of an embodiment described herein, when implemented to execute on a device or data processing system, comprises substantial advancement of the functionality of that device or data processing system in presenting content on a public board. For example, prior-art only presents pre-selected content in a pre-determined manner of presentation, without regard to the changing composition of the audience. An embodiment dynamically assesses the composition of a changing audience and configures the locale settings of the content according to the audience of the public board at a given time. An embodiment also dynamically selects the content according to dynamically changing common interests in the audience and presents the content corresponding to a common interest in a preferred locale setting. Such manner of presenting content to audience via a public board is unavailable in presently available devices or data processing systems. Thus, a substantial advancement of such devices or data processing systems by executing a method of an embodiment is in increasing the relevance of the content to the audience thereby increasing an effectiveness of the content or an objective behind the content.

The illustrative embodiments are described with respect to certain content, locale preferences or settings, languages, identifications, information sources, communications, audience compositions, locations, weighting rules, thresholds, orders, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments.

Furthermore, a particular illustrative embodiment may have some, all, or none of the advantages listed above.

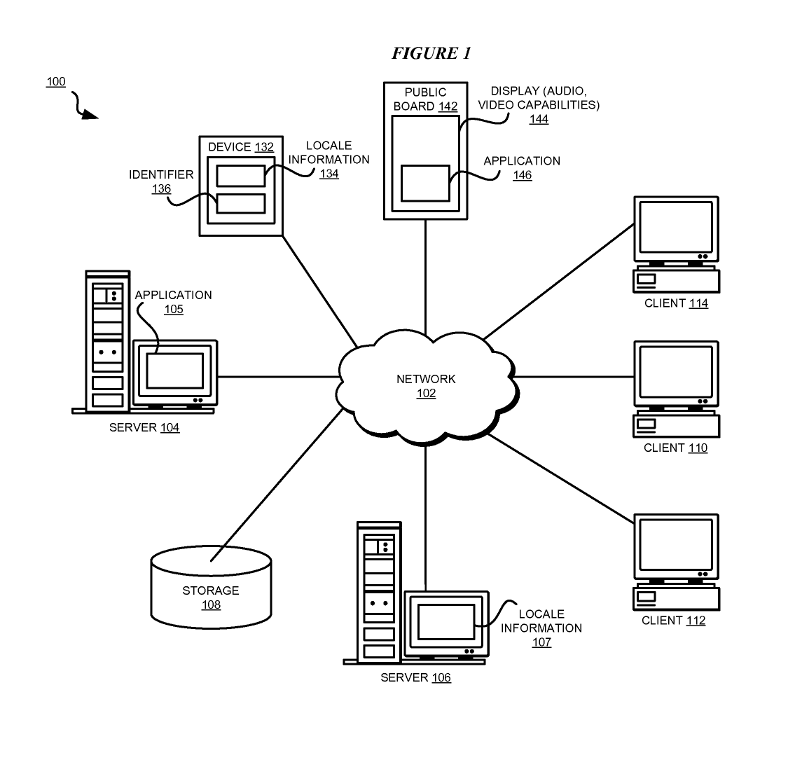

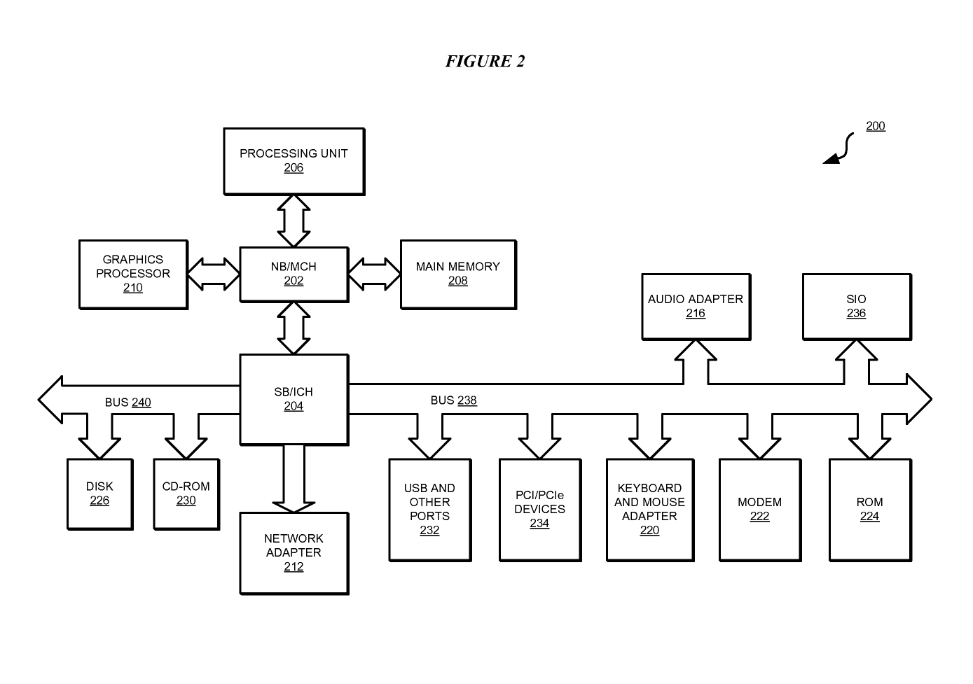

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Public board 142 is an example of a public board described herein. Display 144 is any suitable interface of public board 142 to communicate audible content, visual content, or both. When public board 142 includes a data processing system, application 146 implements an embodiment described herein and executes in public board 142. When public board 142 is coupled to a remote data processing system over a data network, such as to server 104, application 105 implements an embodiment described herein and executes to present configured content on public board 142. Applications 105 and 146 utilize a data collection mechanism, such as an antenna (not shown) at the location of public board 142. Device 132 is an example of a mobile device described herein, and is associated with a member of a dynamic audience of public board 142. Device 132 can provide locale information 134, identifier 136, or some combination thereof, to application 146 or 105. As an example, identifier 136 may be associated with device 132 or with a subscriber or user of device 132. When locale information is not available from device 132, application 146 or 105 sends identifier 136 of device 132 to an external data source, such as to server 106 operated by a service provider. Server 106 provides locale information 107 corresponding to device 132, to application 146 or 105, in such cases.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 and public board 142 in FIG. 1 in which computer usable program code or instructions implementing the processes of the illustrative embodiments may be located. Data processing system 200 is described as a computer only as an example, without being limited thereto. Implementations in the form of other devices, such as device 132 and public board 142 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as applications 105 and 146 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

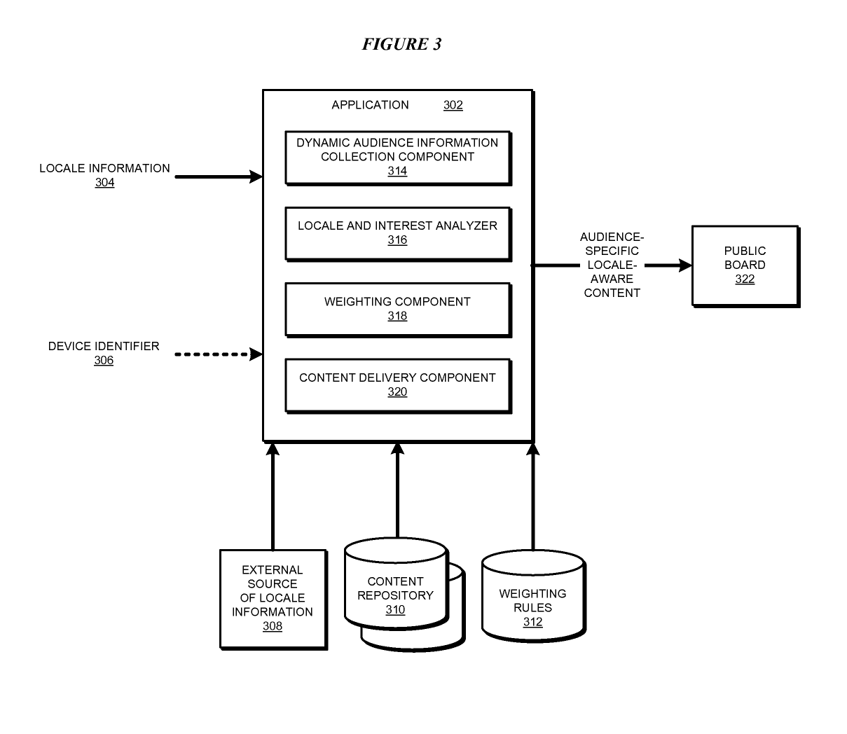

With reference to FIG. 3, this figure depicts a block diagram of an example configuration for locale-aware customization of public content in accordance with an illustrative embodiment. Application 302 is an example of application 146 or application 105 in FIG. 1.

Locale information 304 is a locale preference and is similar to locale information 134 or 107 in FIG. 1. Device identifier 306 is an example of identifier 136 in FIG. 1, and is usable for obtaining locale information from a source other than the mobile device with which device identifier 306 is associated. For example, device identifier 306 is usable for obtaining the locale information similar to locale information 304, from source 308, which is an example of server 106 in FIG. 1.

Content repository 310 is one or more repository of content that can be presented to an audience in a manner described herein. For example, different content repositories 310 may be configured to serve content configured according to different locale settings, different interests, or some combination thereof. A set of one or more weighting rules 312 may also be available to application 302 for use in a manner described herein.

In an example configuration, component 314 of application 302 operates to collect information from the mobile devices present in a dynamic audience. For example, component 314 collects locale information 304 when available or inferable in some communication from a mobile device. When a mobile device does not provide the locale information, component 314 uses identifier 306 to obtain the corresponding locale information from source 308. Component 314 collects locale information 304 from one or more mobile devices in a given audience at a given time.

Component 316 analyzes locale information 304 collected from the one or more mobile devices and/or source 308. The analysis of the collected locale information at component 316 results in one or more common locale preferences.

In some cases, interest information may be a part of the information collected by component 314. When interest information is available, component 316 analyzes the interest information as well. The analysis of the collected interest information at component 316 results in one or more common interests.

Component 318 applies one or more weighting rules 312 to the one or more common locale preference, one or more common interests, or a combination thereof, produced by component 316. Component 318 produces one or more weighted common locale preference, a preferred order of one or more weighted common locale preference, one or more weighted common interest, a preferred order of one or more weighted common interest, or a combination thereof.

When content repository 310 provides content configured according to different locale settings, component 320 uses a weighted common locale preference to select a suitable content that is configured according to the weighted common locale preference. When content repository 310 provides content configured according to a specific locale setting, component 320 uses a weighted common locale preference to select a suitable content, and configure the selected content according to the weighted common locale preference. For example, as a part of configuring the selected content, component 320 may change a formatting, translate into a different language, adjust a pronunciation to a dialect, or apply other locale-specific modifications to a portion of the selected content.

When weighted common interest is also available from component 318, component 320 uses the weighted common interest to select content corresponding to the weighted common interest from repository 310. Depending on whether the selected content of interest is already configured or remains to be configured according to a weighted common locale preference, component 320 configures the selected content of interest as described herein.

Component 320 delivers the configured content to public board 322. Thus, the content delivered to public board 322 is dynamically configured to be audience-specific and locale-aware by application 302.

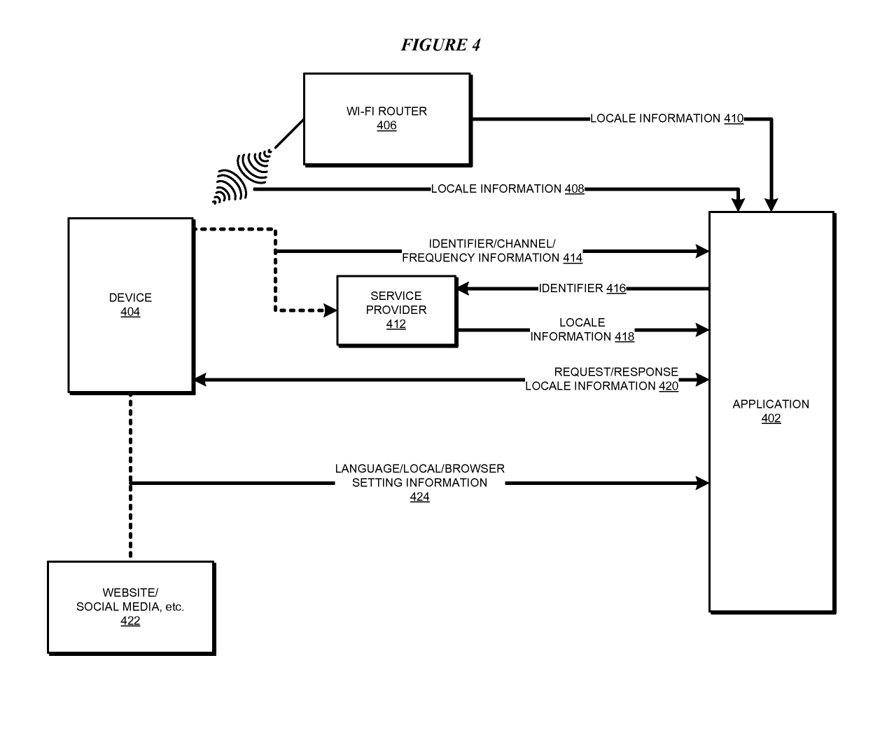

With reference to FIG. 4, this figure depicts a configuration to collect locale preferences from an audience in accordance with an illustrative embodiment. Application 402 is an example of application 302 in FIG. 3. Device 404 is an example f device 132 in FIG. 1.

As described herein, application 402 can collect the locale information in a variety of ways. Some of these ways are depicted in this figure. As one example, device 404 may attempt to establish a wireless network connection by requesting access from Wi-Fi router 406. Wi-Fi router 406 may be a router or an access point of a suitable type. According to one embodiment, application 402 can collect the wireless data transferring between device 404 and router 406, which can include locale information 408. The authentication and handshaking phase of establishing a wireless connection is one example of such wireless data transfer. Alternatively, according to another embodiment, application 402 can have a pre-defined relationship with router 406, whereby router 406 supplies device 404's locale information 410 to application 402 when device 404 requests a connection.

As another example, device 404 may communicate with wireless service provider system 412, such as a base station or a backend server. According to one embodiment, application 402 can collect the channel or frequency information used by device 404 for such communications, which can include information 414. In some cases, information 414 may contain locale information. In some other cases, information 414 may contain an identifier associated with device 404. In some other cases, information 414 may contain an identifier associated with device 404 as well as locale information.

When information 414 only provides an identifier, application 402 requests the locale information corresponding to device 404 by sending the received identifier as identifier 416 to service provider system 412. In response, system 412 provides locale information 418 of device 404.

As another example, application 402 can obtain the locale information from device 404 simply by requesting the locale information and receiving the locale information in response, in request-response pair 420. As another example, device 404 may attempt to establish a session with website or social media service 422. According to one embodiment, application 402 can collect the wirelessly transmitted data between device 404 and a network connecting to website or social media service 422. Such data often includes locale information 424, which application 402 filters from the collected data.

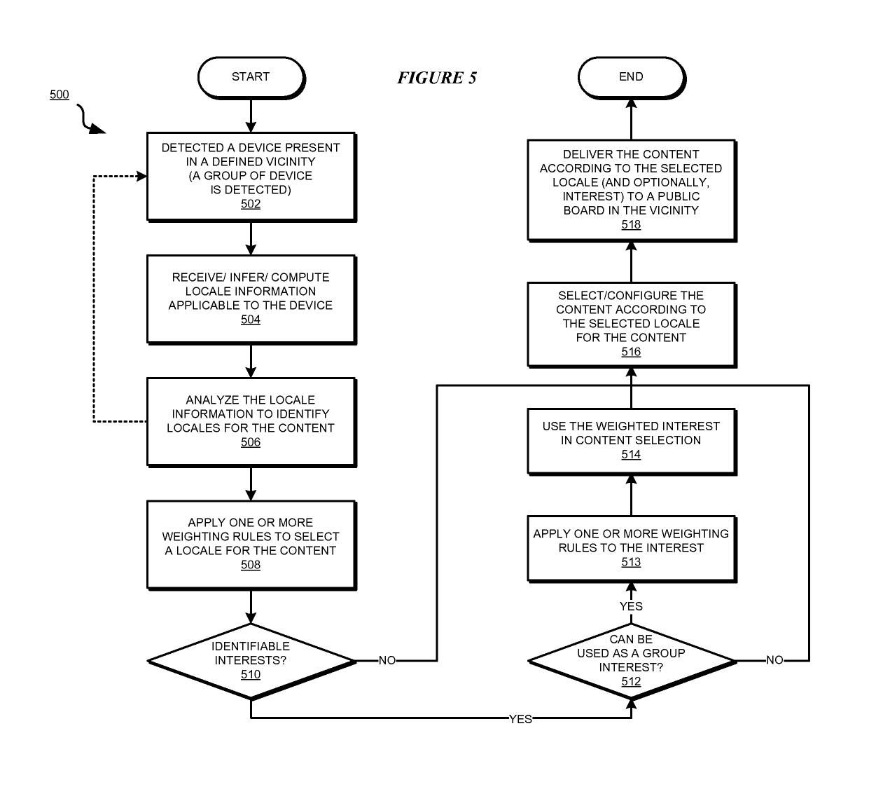

With reference to FIG. 5, this figure depicts a flowchart of an example process for locale-aware customization of public content in accordance with an illustrative embodiment. Process 500 can be implemented in application 402 in FIG. 4.

The application detects the presence of a mobile device associated with a member of an audience in a defined vicinity of a public board (block 502). Any number of mobile devices may be detected at block 502.

The application receives, infers, computes, or otherwise collects the locale preference—or locale information—that is applicable to the detected device (block 504). The application analyzes the collected locale information from one or more devices to identify a common locale that is usable for configuring content for the public board (block 506). The application repeats blocks 502-506 periodically to account for any number of devices that may enter and/or leave the vicinity.

The application applies a weighting rule to a common locale information to select a locale setting for the content (block 508). Any number of weighting rules can be applied to select one or more locale settings for one or more pieces of the content.

Optionally, the application also determines whether any interest information is identifiable from the information collected in block 504 (block 510). If no interest information is identifiable from the information collected in block 504 (“No” path of block 510), the application proceeds to block 516. If an interest information is identifiable from the information collected in block 504 (“Yes” path of block 510), the application determines whether the interest information is usable as an interest of a group, to wit, at least some members, in the audience (block 512).

If the interest information is not usable as an interest of a group in the audience (“No” path of block 512), the application proceeds to block 516. If the interest information is usable as an interest of a group in the audience (“Yes” path of block 512), the application applies one or more weighting rules to the identified interest (block 513). When the weighted interest qualifies for selecting the content, such as when the weight of weighted interest exceeds a threshold value, the application uses the weighted interest in selecting the content (block 514).

The application proceeds to select the content, if not already selected according to the locale from block 508, interest from block 513, or both, or configure the selected content according to the weighted locale from block 508 (block 516). The application delivers to the public board in the vicinity the configured content according to the selected locale from block 508, selected interest from block 513, or both (block 518). The application ends process 500 thereafter.

Thus, a computer implemented method is provided in the illustrative embodiments for locale-aware customization of public content. Where an embodiment or a portion thereof is described with respect to a type of device, the computer implemented method or a portion thereof, are adapted or configured for use with a suitable and comparable manifestation of that type of device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for customizing content according to a dynamically changing audience, the method comprising:
detecting that a mobile device is present within a defined area, the mobile device being associated with a first member of the audience;
collecting, from the mobile device, a first locale preference corresponding to the first member;
analyzing the first locale preference to determine whether the first locale preference is also a locale preference of a threshold number of members of the audience;
weighting, responsive to the first locale preference also being the locale preference of the threshold number of members of the audience, the first locale preference according to a weighting rule to form a weighted common locale preference;
selecting, responsive to a weight of the weighted common locale preference exceeding a threshold weight, the weighted common locale preference for the content;
configuring the content according to the weighted common locale preference, forming customized content; and
delivering the customized content to a public presentation device present in the defined area.

2. The method of claim 1, further comprising:
collecting, from the mobile device, a first information corresponding to the first member, the first information comprising a topic of interest of the first member;
analyzing the topic of interest of the first member to determine whether the topic of interest of the first member is also a topic of interest of a second threshold number of members of the audience;
weighting, responsive to the topic of interest of the first member also being the topic of interest of the second threshold number of members of the audience, the topic of interest of the first member according to a second weighting rule to form a weighted topic of interest; and
selecting the content, wherein the content corresponds to the weighted topic of interest.

3. The method of claim 1, further comprising:
assigning, as a part of the weighting, a first weight to the first locale preference and a second weight to a second locale preference, wherein the first locale preference is the locale preference of the threshold number of members of the audience, and wherein the second locale preference is a common locale preference of less than the threshold number of members of the audience; and
replacing, as a part of the weighting, the first locale preference with the second locale preference responsive to the first weight being less than the second weight.

4. The method of claim 1, further comprising:
receiving a data of a communication occurring between the mobile device and a networking device; and
extracting from the data the first locale preference.

5. The method of claim 1, further comprising:
receiving the first locale preference from a networking device, wherein the mobile device establishes a data communication with networking device, and wherein the locale information is computed from data of the data communication.

6. The method of claim 1, further comprising:
determining, as a part of the collecting, a frequency used by the mobile device to communicate with a service provider system; and
identifying the first locale preference using the frequency.

7. The method of claim 1, further comprising:
determining, as a part of the collecting, an identifier associated with the mobile device, wherein the identifier is present in a data communication between the mobile device and a service provider system; supplying the identifier to a second service provider system; and
receiving, responsive to the supplying, the first locale preference from the second service provider system.

8. The method of claim 1, further comprising:
receiving a data of a communication occurring between the mobile device and a website; and
extracting from the data the first locale preference.

9. The method of claim 1, further comprising:
receiving a data of a communication occurring between the mobile device and a social media service; and
extracting from the data the first locale preference.

10. The method of claim 1, wherein the defined area is defined using a distance from the public presentation device.

11. The method of claim 1, wherein the audience is dynamically changing such that the first member is present in the defined area at a first time and absent from the defined area at a second time, and wherein a second mobile device associated with a second member having a second locale preference is present in the defined area at the second time.
